(19) United States
(12) Patent Application Publication
(10) Pub. No.: US 2016/0034048 A1
(43) Pub. Date: Feb. 4, 2016

(54) VIDEO DISPLAY SYSTEM, THREE-DIMENSIONAL VIDEO POINTING DEVICE AND VIDEO DISPLAY DEVICE

(71) Applicant: Hitachi Maxell, Ltd., Osaka (JP)

(72) Inventors: Kazuhiko TANAKA, Tokyo (JP); Mitsuo NAKAJIMA, Tokyo (JP); Nobuhiro FUKUDA, Tokyo (JP); Nobuaki KABUTO, Tokyo (JP); Hiroki MIZOSOE, Tokyo (JP)

(21) Appl. No.: 14/738,099

(22) Filed: Jun. 12, 2015

(30) Foreign Application Priority Data
Jul. 29, 2014 (JP) 2014-154315

(51) Int. Cl. G06F 3/03

(52) U.S. Cl. CPC G06F 3/0304

(57) ABSTRACT

A video display system includes: a display device that displays a video, which constitutes a stereoscopic video, on its surface; and a light beam emitting device capable of pointing to one point with scattering light obtained by projecting a non-visible light beam or a visible light beam onto the surface, the display device has a camera capable of capturing the scattering light and a superimposition unit that superimposes a pointer image on a display video, and the superimposition unit superimposes the pointer image on the display video depending on a position of the scattering light captured by the camera.

### CROSS-REFERENCE TO RELATED APPLICATION

The present application claims priority from Japanese Patent Application No. 2014-154315 filed on Jul. 29, 2014, the content of which is hereby incorporated by reference into this application.

### TECHNICAL FIELD OF THE INVENTION

The present invention relates to a technique for pointing to a position on a three-dimensional video.

### BACKGROUND OF THE INVENTION

As a method for pointing to a location on a video displayed on a screen by a projector or the like, a laser pointer using laser light has been widely used.

Meanwhile, as a liquid crystal display and a projector, a product in which a stereoscopic video or a so-called three-dimensional (3D) video is displayed by presenting different videos respectively to left and right eyes has been released. In these devices, videos to be presented to left and right eyes are displayed on a screen of the display and the projector in a superimposed manner, and the videos are separated by using polarization glasses or shutter glasses so as to present only videos corresponding to the left and right eyes to the respective eyes, thereby achieving the 3D display. In this case, an object to be displayed is displayed at different positions on the videos presented to the left and right eyes, and the resulting parallax between the left and right eyes represents a depth feeling.

However, when a pointing operation is performed by using a normal laser pointer for the left and right videos displayed in a superimposed manner, the same coordinates on the left and right videos are pointed to. Since the object to be displayed is displayed at different positions in the left and right videos as described above, the laser pointer points to different objects in the video for the left eye and the video for the right eye. Therefore, it is not possible to correctly point to the stereoscopically displayed object.

For the solution thereof, Japanese Patent Application Laid-Open Publication No. 2005-275346 (Patent Document 1) describes a method in which spot light is shone onto different positions for left and right videos by using a pointer provided with two laser light sources.

### SUMMARY OF THE INVENTION

However, in the method described in Japanese Patent Application Laid-Open Publication No. 2005-275346, a laser pointer becomes large because it is provided with a plurality of laser light sources. Moreover, since high accuracy is required to adjust their optical axes, there is an issue in terms of cost. Moreover, when the way of holding the laser pointer is inappropriate, it is difficult to appropriately maintain a positional relationship between two spot light beams, and an object to be a target may not be correctly pointed to.

Thus, an object of the present invention is to provide a video display system, a three-dimensional video pointing device, and a video display device capable of more appropriately pointing to a position in a stereoscopic video.

For the solution of the problem described above, for example, a video display system includes: a display device that displays a video, which constitutes a stereoscopic video, on its surface; and a light beam emitting device capable of pointing to one point with scattering light obtained by projecting a non-visible light beam or a visible light beam onto the surface, the display device has a camera capable of capturing the scattering light and a superimposition unit that superimposes a pointer image on a display video, and the superimposition unit superimposes the pointer image on the display video depending on a position of the scattering light captured by the camera.

When the method according to the present invention is used, it is possible to appropriately point to a position in a stereoscopic video.

### BRIEF DESCRIPTIONS OF THE DRAWINGS

FIG. 1 is a diagram illustrating a system configuration in a first embodiment;

FIG. 2 is a diagram illustrating how an object looks in a 3D video;

FIG. 3 is a diagram illustrating an example of an illumination position of a laser pointer;

FIG. 4 is a diagram illustrating an example of an illumination position of a laser pointer;

FIG. 5 is a diagram illustrating a position at which a pointer image is superimposed;

FIG. 6 is a diagram illustrating extraction of a feature point and calculation of pointer superimposing coordinates;

FIG. 7 is a diagram illustrating an internal configuration of a projector in the first embodiment;

FIG. 8 is a processing flow in the first embodiment;

FIG. 9 is a diagram illustrating a system configuration in a second embodiment;

FIG. 10 is a diagram illustrating an internal configuration of a projector in the second embodiment;

FIG. 11 is a diagram illustrating a system configuration in a third embodiment;

FIG. 12 is a diagram illustrating a system configuration in a fourth embodiment; and

FIG. 13 is a diagram illustrating an internal configuration of a liquid crystal display in the fourth embodiment.

### DESCRIPTIONS OF THE PREFERRED EMBODIMENTS

### First Embodiment

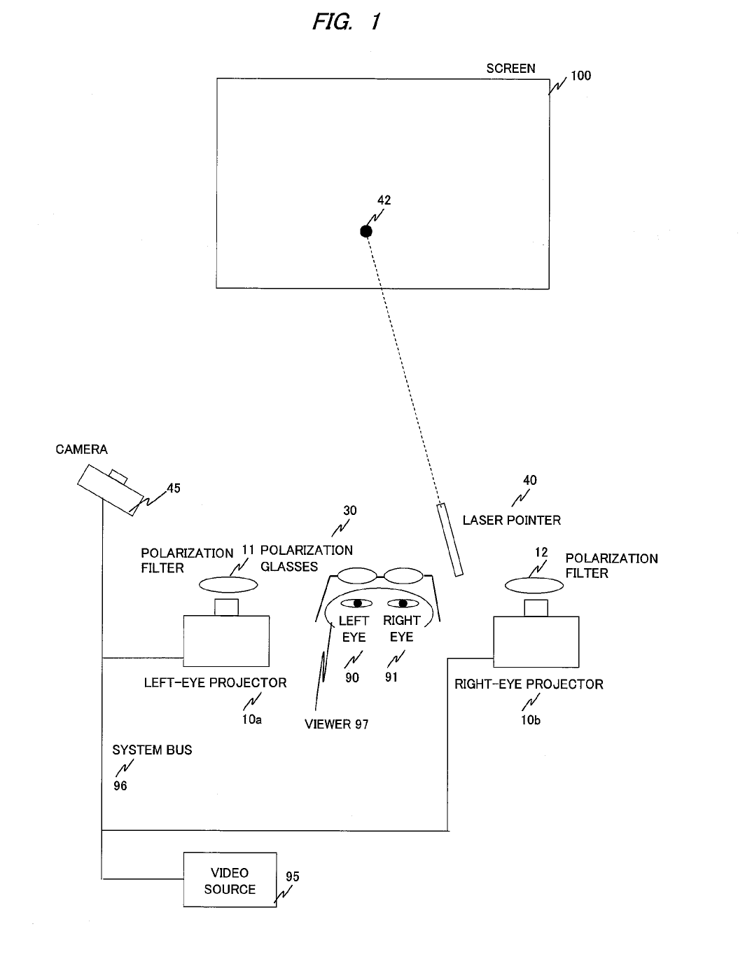

Hereinafter, a system configuration in a first embodiment of the present invention will be described with reference to FIG. 1.

In FIG. 1, 100 denotes a screen on which a video is projected, and 10a and 10b denote projectors which respectively project videos corresponding to left and right eyes onto the screen 100. In the present embodiment, the projectors 10a and 10b having the same structure are assumed, and are collectively referred to as a projector 10.

A viewer 97 is a person who views the video projected onto the screen 100. Although only one viewer is illustrated in FIG. 1, in practice, there are generally a plurality of viewers and an effect of the present invention is not limited by the number of viewers.

90 and 91 denote left and right eyes of the viewer 97, and the viewer 97 views the videos projected onto the screen 100 through polarization glasses 30 worn by the viewer 97. In the polarization glasses 30, filters different in polarization direction are attached for left and right eyes in such a manner that the filter for the left eye polarizes light in a vertical direction and the filter for the right eye polarizes light in a horizontal direction.

The polarization direction is not limited to such a linear polarization direction, and other polarization directions such as a circular polarization direction are also acceptable. A polarization filter 11 and a polarization filter 12 are respectively attached to front surfaces of the projectors 10a and 10b corresponding to the left and right eyes, and their respective polarization directions are aligned with those of the filters for left and right eyes of the polarization glasses 30. In this manner, the video projected from the left-eye projector 10a can be seen with only the left eye 90 and the video projected from the right-eye projector 10b can be seen with only the right eye 91. Although the structure in which the polarization filters 11 and 12 are respectively attached to the front surfaces of the projectors 10a and 10b has been described here for the convenience of description, these filters can also be attached to inner parts of the projectors 10a and 10b.

45 denotes a camera 45 to capture the screen. In the present embodiment, a camera capable of capturing both visible light and infrared light is assumed. The camera 45 may be built in the projector 10. When the camera built in the projector 10 is used, the external camera 45 is not necessary.

A video source 95 is a device that generates display videos respectively corresponding to the left and right eyes, and a BD player, a personal computer and a game machine compliant with 3D display correspond thereto. Although the case where the video source 95 is disposed outside the projector 10 has been described in the present embodiment, the video source 95 can also be built in the projector 10.

A system bus 96 is an information transmission bus which connects these devices, and is constituted of, for example, HDMI (registered trademark) for transmitting a video and Ethernet (registered trademark) for transmitting data. A part or all of data transfer on the system bus 96 can also be replaced with wireless communication such as a wireless LAN.

40 denotes a laser pointer which performs an operation for pointing to an object, which is being projected by the projector 10, by using laser light. Although the laser pointer 40 which emits infrared light is assumed in the present embodiment, the laser pointer may have a mechanism to switch infrared light and visible light with a switch or the like in consideration of use in a video other than a 3D video.

42 denotes a spot light displayed by the laser pointer 40 onto the screen 100. Although the spot light is infrared light and is thus invisible to human eyes, the camera 45 can capture the spot light because it is compliant also with infrared imaging.

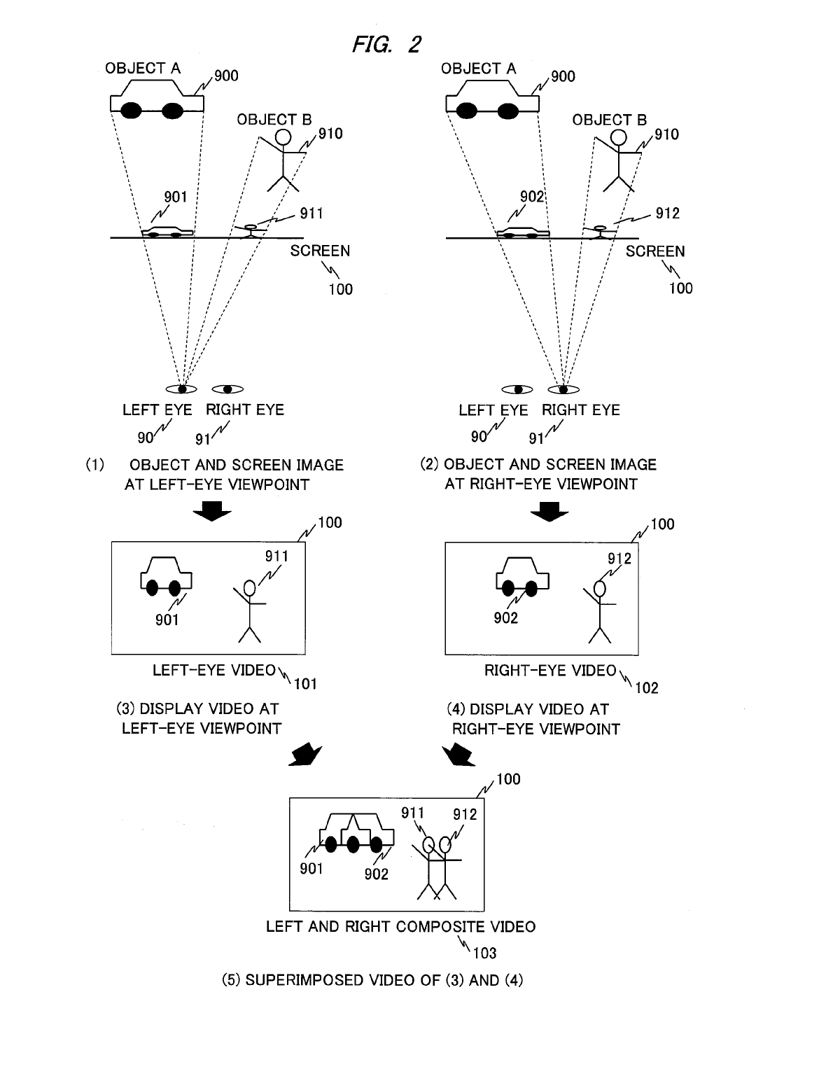

Next, a relationship between an object to be displayed and left and right videos when 3D display is performed will be described below with reference to FIG. 2.

In FIGS. 2, 90 and 91 denote the left eye and the right eye of the viewer 97 of a video, and 100 denotes a screen placed in an actual installation location.

It is presupposed that two objects, namely, an object A and an object B are displayed on the video assumed this time. In FIG. 2, 900 denotes a position where the object A is placed and 910 denotes a position where the object B is placed in a three-dimensional display space, respectively. As illustrated in FIG. 2, it is assumed that the object A exists farther than the object B as viewed from the viewer 97 and both the objects A and B are in practice farther than the position 100 where the screen is placed. The present embodiment is not limited to this, and even a case where the objects are closer than the screen 100 is also applicable.

In this example, assuming the case where the objects are viewed from a position of the left eye 90, as illustrated in (1) of FIG. 2, the object A is displayed at a position 901 and the object B is displayed at a position 911 on the screen, respectively. On the other hand, assuming the case where the objects are viewed from a position of the right eye 91, as illustrated in (2) of FIG. 2, the object A is displayed at a position 902 and the object B is displayed at a position 912 on the screen, respectively. More specifically, a left-eye video 101 and a right-eye video 102 are respectively as illustrated in (3) and (4) of FIG. 2.

Since these videos are projected onto the screen 100 by the projectors 10a and 10b respectively through the polarization filters 11 and 12, when the projected videos are viewed without wearing the polarization glasses, the left and right videos are overlapped with each other and are seen like a double image (left and right composite video 103) as illustrated in (5) of FIG. 2. Here, the deviation between the left and right videos corresponds to a parallax between the left and right eyes, and the object A located far has a larger parallax than the object B located near in this example.

When the left and right composite video 103 is viewed with wearing the polarization glasses 30, the left-eye video 101 and the right-eye video 102 are respectively presented to the left eye 90 and the right eye 91, and the brain of the viewer recognizes the parallax of the objects, so that the objects A and B seem to respectively exist at the positions 900 and 910 and are recognized as a stereoscopic video.

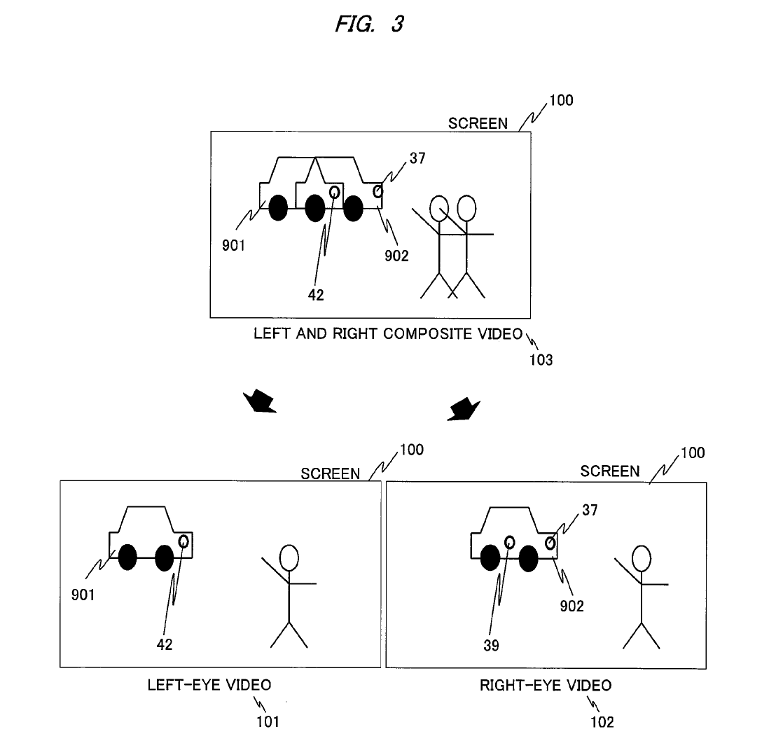

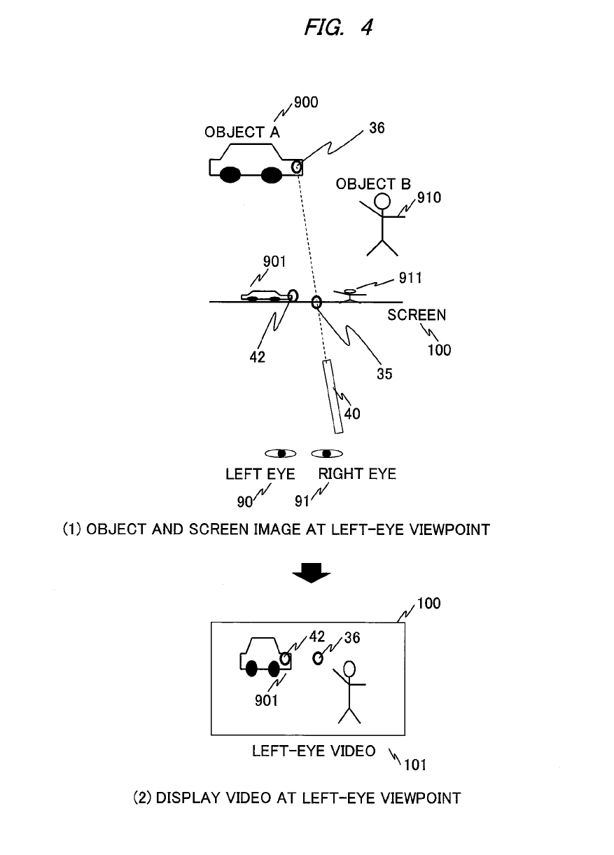

Next, a problem which occurs when an object in a 3D video is pointed to by using the laser pointer 40 will be described below based on the examples illustrated in FIG. 3 and FIG. 4. The case where a right end of the object A, namely, a bonnet of a car is pointed to as a point to be noted is considered.

When an object in the 3D video is pointed to, strictly, it is optimum that a point 35 at which a straight line connecting the laser pointer 40 and a point to be noted 36 at the actual position 900 of the object A crosses the screen 100 is pointed to by the laser pointer 40 as illustrated in (1) of FIG. 4. In the present embodiment, however, in order to achieve this in a simple configuration, a point to be noted 42 in the image 901 of the object A in the left-eye video 101 on the screen 100 illustrated in (2) of FIG. 4 is pointed to by the laser pointer 40.

This is to simplify the operation by utilizing the fact that when a human uses a laser pointer, the human unconsciously operates the pointer so as to eliminate the relative error between the pointer image displayed already and the point to be noted unlike the case of shooting in which the point to be noted is exactly aimed. Thus, in a pointing operation based on a relative position with the current pointer image, it is not necessary to strictly match an absolute position if a relative positional relationship is correct to some extent. The laser pointer 40 is pointed to the point 42 on the bonnet in the image 901 in the left-eye video 101 illustrated in FIG. 3 in the present embodiment. Alternatively, the laser pointer 40 may be pointed to a point 37 on the bonnet in an image 902 in the right-eye video 102 illustrated in FIG. 3 or may be pointed to an intermediate point between the point 42 and the point 37.

When the pointing operation is performed by the laser pointer 40 based on the left-eye video 101 as described above, if there is a parallax for the objects, a different position is pointed to on the right-eye video 102. In this example, as illustrated in FIG. 3, when a location of the point 42 is pointed to by the laser pointer 40 in a left and right composite video 103, the point 42 at the bonnet of the car to be a target is pointed to in the left-eye video 101, but the point 39 at the center of the car is pointed to in the right-eye video 102 (coordinates corresponding to the point 42 in the left-eye video). When positions of the object to be pointed to in the left-eye and right-eye videos differ as described above, if the laser pointer 40 emits visible light, the brain of a human cannot correctly interpret a position of the pointer stereoscopically.

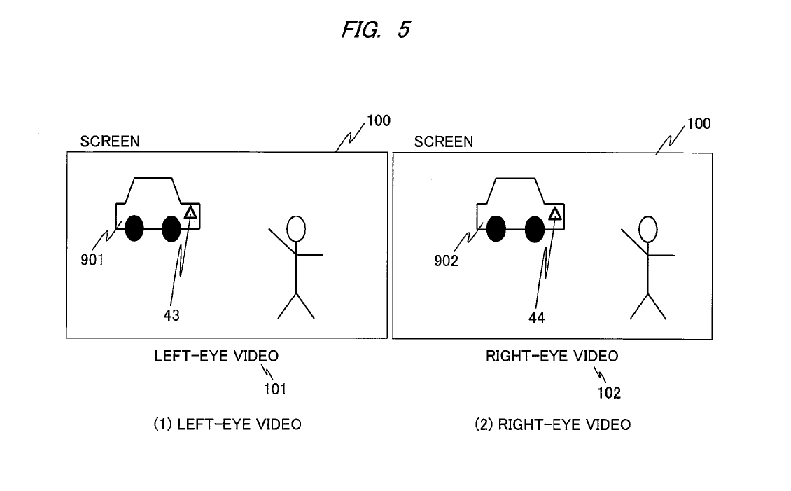

Here, the superimposition of a pointer image for correctly displaying the pointer image at the bonnet of the car on the stereoscopic video will be described with reference to FIG. 5. In the method of the present embodiment, the laser pointer 40 emits infrared light invisible to the human eyes to the point 42 and the position of the point 42 to be pointed is detected by capturing the pointer image by the camera 45. Since the camera 45 captures visible light simultaneously with infrared light, a position of an outer frame of the screen 100 is acquired with the visible light and is aligned with the point position acquired with the infrared light, so that the position of the point 42 can be acquired as coordinate data in the left-eye video 101.

Also, though not illustrated in FIG. 1, it is possible to acquire the left-eye image 101 and the pointer position 42 by the camera 45 in such a manner that a polarization filter is attached to the front surface of the camera 45 so that the right-eye image 102 is not captured by the camera 45, and it is also possible to acquire the point position as the coordinate data in the left-eye video 101 by the matching processing therebetween. In this method, even if the outer frame of the screen and the left-eye video 101 are not aligned with each other, correct coordinates of the point position can be obtained.

By the foregoing method, the coordinate data of the pointer image 42 in the left-eye video 101 can be obtained, and thus a pointer image 43 is superimposed on the left-eye video 101 as illustrated in (1) of FIG. 5. Further, coordinate data of a pointer image in the right-eye video 102 is calculated by using the coordinate data of the pointer image in the left-eye video 101, and the pointer image 44 is superimposed on the right-type video 102 as illustrated in (2) of FIG. 5 . The two images are projected by the system illustrated in FIG. 1 and are viewed through the polarization glasses 30, so that the pointer image can be correctly displayed at the bonnet of the car on the stereoscopic video.

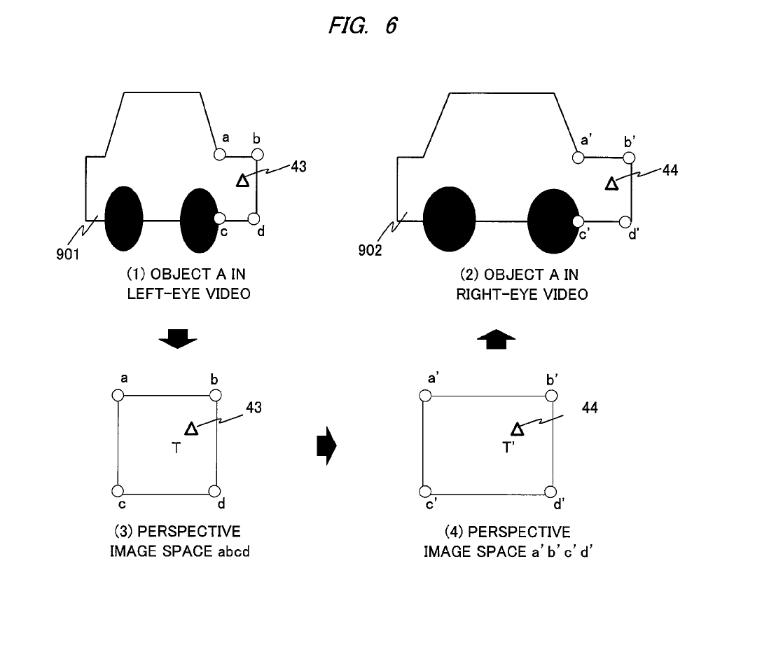

Here, a method for implementing “processing for calculating coordinate data of a pointer image in the right-eye video 102 by using coordinate data of a pointer image in the left-eye video 101” which has been performed in a series of processes mentioned above will be described with reference to FIG. 6. In this processing, characteristic points in a video such as a boundary and a corner of an object are extracted as feature points from the left-eye video 101. In (1) of FIG. 6, four points a, b, c and d close to a point to be noted 43 are extracted as feature points. By defining a coordinate system with the four points, coordinates of the point to be noted 43 in the coordinate system are determined. Although a quadrangle having apexes at the four points a, b, c and d has a shape close to a square in this example, any quadrangle is applicable.

When the right-eye video 102 illustrated in (2) of FIG. 6 is searched for points corresponding to the points a, b, c and d by using changes in the color and the luminance of pixels, four points a′ , b′ , c′ and d′ can be extracted as corresponding feature points. Since a coordinate space defined by the four points and a coordinate space defined by the four points a, b, c and d can be converted by perspective transformation, it is possible to determine which location in the coordinate space defined by the four points a′ , b′ , c′ and d′ the point to be noted 43 corresponds to. Thus, from a point T in the coordinate space abcd, a corresponding point T′ in the coordinate space a′b′c′d′ can be found.

By reflecting this on the right-eye video illustrated in (2) of FIG. 6, a display position 44 of a pointer image in the right-eye video 102 can be obtained.

Although the pointer images are respectively superimposed on the left-eye video and the right-eye video in the above-described example, an effect of pointing to an appropriate position is obtained even by superimposing the pointer image on only the video for one eye. In this case, processing using the feature points and superimposition processing of the pointer image for the video of the other eye described above can be omitted.

The calculation processing and the superimposition of the pointer image may be performed at any location as long as information from the camera 45 can be received and the video for at least one eye can be processed. For example, it may be performed in either one of the left-eye projector 10a and the right-eye projector 10b. Alternatively, the left-eye projector 10a and the right-eye projector 10b may perform them in cooperation with each other, or the video source 95 may perform them.

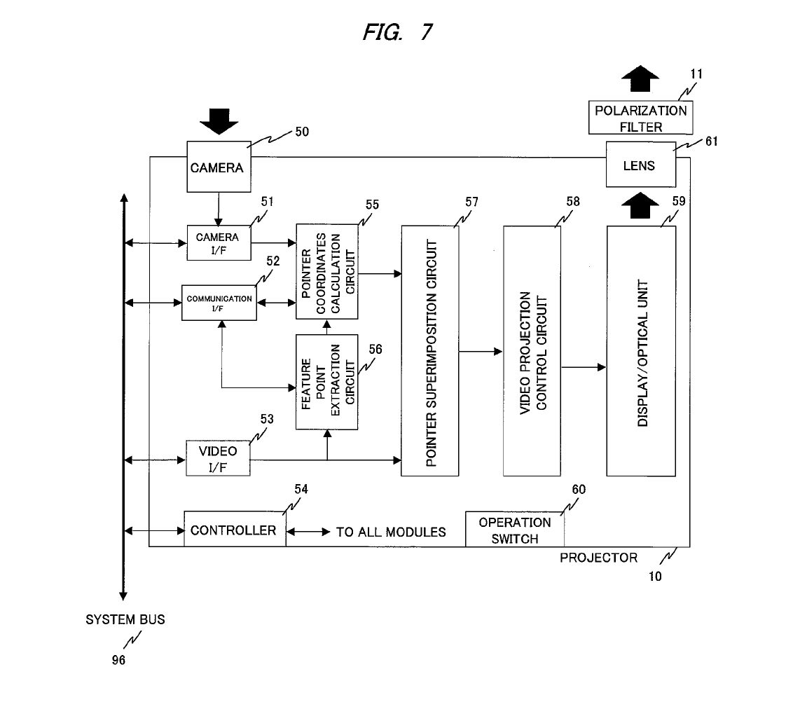

Next, an example of an internal structure of the projector 10 will be described below with reference to FIG. 7.

In FIG. 7, 51 denotes a camera interface, and it is a circuit for receiving video from the camera 45 in the present embodiment.

A camera 50 is built in the projector 10, and is not used in the present embodiment, but it can be used instead of the camera 45.

52 denotes a communication interface, and it is used for communication between projectors and others. 53 denotes a video interface, and it is a circuit for inputting a video to be displayed by the projector 10.

54 denotes a controller which controls the entire projector, and although illustration of the connection thereof is omitted in FIG. 7 in order to avoid the drawing from being complicated, it is connected to each of modules in the projector 10.

56 denotes a feature point extraction circuit, and it extracts the feature points described in FIG. 6 from an input video. The respective feature point extraction circuits 56 in the projectors communicate with each other via the communication interfaces 52, and also perform the matching between the feature points.

55 denotes a pointer coordinate calculation circuit 55, and it performs slightly different operations in the left-eye projector 10a and the right-eye projector 10b in the present embodiment.

The pointer coordinate calculation circuit 55 mounted in the left-eye projector 10a calculates which location of the left-eye video 101 a position of a pointer obtained from the camera interface corresponds to, and calculates pointer coordinates (corresponding to 43 in FIG. 5) in the left-eye video 101.

The pointer coordinate calculation circuit 55 mounted in the right-eye projector 10b calculates pointer coordinates (corresponding to 44 in FIG. 5) in the right-eye video 102 from the pointer position in the left-eye video 101 acquired via the communication interface 52 and coordinates of the feature point obtained by the feature point extraction circuit 56.

In a pointer superimposition circuit 57, a video of the pointer is superimposed on the video input from the video interface 53 by using the pointer coordinates thus obtained.

The video obtained by the superimposition is output as a display video by a video projection control circuit 58 and a display/optical unit 59 made up of, for example, a lamp, a liquid crystal panel, a mirror and a lens. The output video is projected onto the screen 100 through a lens 61 and a polarization filter 11.

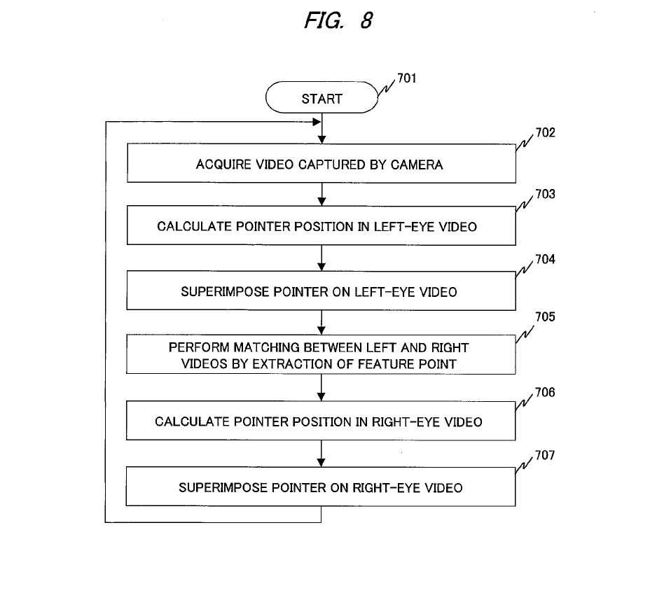

FIG. 8 illustrates a flow of the series of processes with a flowchart.

When processing is started (701), a video obtained by capturing the screen 100 with the camera 45 is first acquired (702).

The acquired video is sent to the left-eye projector 10a via the system bus 96. In the left-eye projector 10a, a display position of a pointer image to be superimposed on the left-eye video 101 is calculated based on the sent video (703), and the pointer image is superimposed on the left-eye video 101 (704).

Then, information of a feature point and a display position of a left-eye pointer are sent to the right-eye projector 10b from the left-eye projector 10a via the system bus 96.

In the right-eye projector 10b, matching between respective feature points of left and right videos is performed (705), a display position of a pointer image to be superimposed on the right-eye video 102 is calculated (706), and the pointer image is superimposed on the right-eye video 102 (707).

By performing this periodically, the pointer images can be respectively superimposed at appropriate positions of the left and right videos used for the three-dimensional video display. Thus, the pointing operation using the laser pointer can be implemented for a stereoscopic video.

Note that the pointer image may be superimposed on only the video for one eye.

### Second Embodiment

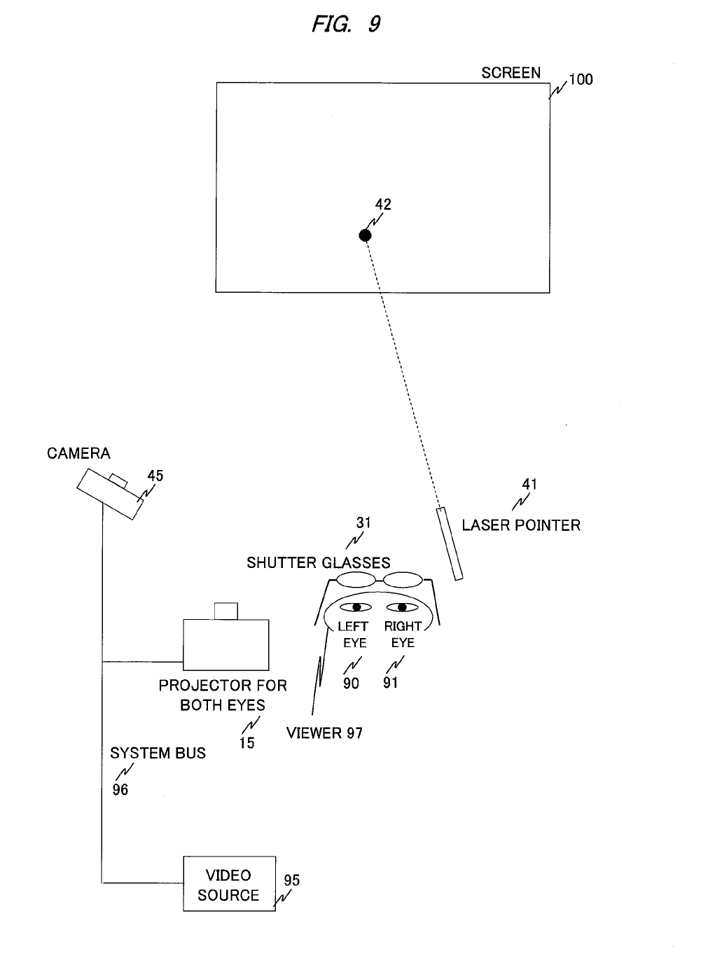

A system configuration in a second embodiment of the present invention will be described with reference to FIG. 9. While a 3D video is displayed by a system using polarization glasses in the first embodiment, the 3D video is displayed with active shutter glasses in the present embodiment. In the 3D display with the active shutter glasses, the left-eye video 101 and the right-eye video 102 are alternately projected from a projector 15 in a time-axis direction.

In this example, the left-eye video 101 is projected from the projector 15 in even-numbered display frames, and the right-eye video 102 is projected therefrom in odd-numbered display frames.

As shutter glasses 31, liquid crystal shutters which operate at different timings for left and right eyes are mounted.

In the present embodiment, the liquid crystal shutters are controlled so that the liquid crystal shutter corresponding to the left eye is opened (light can pass therethrough) and the liquid crystal shutter corresponding to the right eye is closed (light cannot pass therethrough) in a period of time when the left-eye video 101 is projected. On the other hand, the liquid crystal shutters are controlled so that the liquid crystal shutter corresponding to the right eye is opened and the liquid crystal shutter corresponding to the left eye is closed in a period of time when the right-eye video 102 is projected.

A wireless communication unit is mounted in the projector 15, and the shutter glasses 31 can be controlled as described above in synchronization with a video display timing of the projector by making a communication with a wireless communication unit mounted in the shutter glasses 31.

In the present embodiment, a laser pointer 41 is also provided with a wireless communication unit, and includes a mechanism in which a laser light blinks on and off in accordance with a display timing of a video by making a communication with the wireless communication unit built in the projector 15. More specifically, laser light is turned on only in a period during which the left-eye video 101 is displayed from the projector 15.

In this manner, light from the laser pointer 41 seems to be emitted onto only the left-eye video 101 for the viewer 97. Since the pointer position in the left-eye video 101 can be acquired by capturing the screen 100 with the camera 45 at the timing at which the left-eye video 101 is displayed, a pointer image can be displayed in a 3D space by superimposing a right-eye pointer image on the right-eye video 102 in the same manner as that in the first embodiment.

Since stereoscopic view can be implemented by one projector, this system has an advantage that the number of projectors can be reduced in comparison with the system according to the first embodiment. Further, in the present embodiment, light emitted from a laser pointer is directly used as a pointer image for the left-eye video by using a laser pointer of visible light. However, even when a 3D video is displayed by using an active shutter glasses system, a system for superimposing a pointer image on left-eye and right-eye videos by using a laser pointer of infrared light can also be adopted like in the first embodiment.

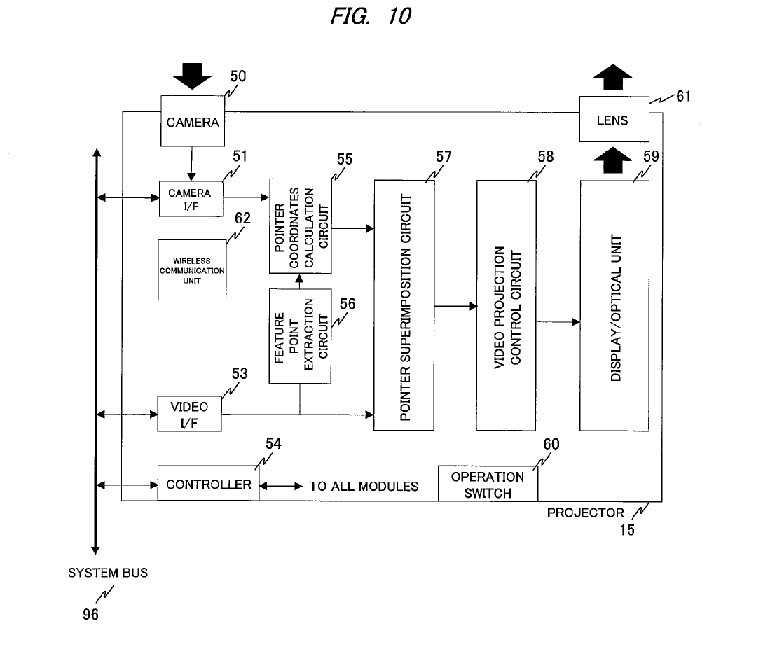

Next, a configuration of the projector 15 in the present embodiment will be described below with reference to FIG. 10. While a basic configuration is the same as that of the first embodiment illustrated in FIG. 7, since communication between two projectors is unnecessary, the communication interface unit 52 is eliminated, and a wireless communication unit 62 is added instead. This unit is connected to a controller 54 and is used for the purpose of notifying the shutter glasses 31 and the laser pointer 41 of the display timing at each frame.

### Third Embodiment

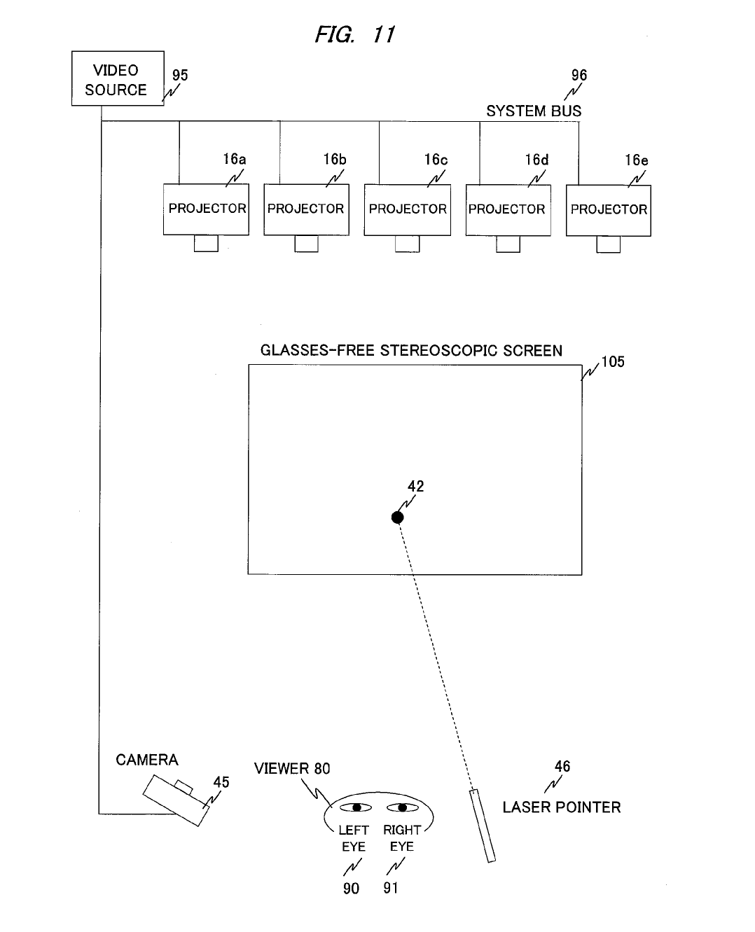

A system according to the present invention is applicable to not only glasses 3D but also glasses-free 3D. This system will be described based on a system configuration illustrated in FIG. 11.

In the glasses-free 3D, videos respectively viewed from several viewpoints are prepared in advance, and when a viewer views a screen, the video corresponding to the line of sight is presented, thereby achieving the stereoscopic view. While the case where five projectors are used is assumed in FIG. 11 in order to avoid the drawing from being complicated, there is no limitation of the number of projectors in the system according to the present invention.

Various systems such as a configuration using a lenticular lens have been proposed as a glasses-free stereoscopic screen mentioned above. Also, as a projection system, not only a system for performing projection from a front surface of a screen like in the first embodiment, but also a rear projection system for performing projection from a rear surface of the screen has been known, and the rear projection system has been widely used at present.

Therefore, also in the present embodiment, a rear projection system for performing projection from a rear surface of a screen by using a projector is assumed.

A basic configuration in the case of applying the present invention to the glasses-free 3D display like this is similar to that in the first embodiment. More specifically, the present embodiment has a configuration in which a laser pointer 46 emits infrared light and the infrared light is captured with the camera capable of capturing infrared light and visible light, thereby acquiring the pointer position. Although an installation position of the camera is not so important in the system according to the first embodiment, the installation position of the camera also becomes an important parameter in the present embodiment. This is because which line of sight the video projected from a projector corresponding to is captured by the camera is changed depending on the installation position of the camera 45.

In the present embodiment, the installation position of the camera 45 is determined so that the video projected from a projector 16a is captured by the camera 45. In this case, the pointing operation on a glasses-free 3D video can be performed by using the system according to the first embodiment by translating the projector 16a as the projector 10a in the first embodiment and other projectors as the projector 10b in the first embodiment.

More specifically, a spot 42 by laser light emitted from the laser pointer 46 is captured by the camera 45, point coordinates in the video projected from the projector 16a are calculated and a pointer image is superimposed on a display video of the projector 16a. Further, pointer superimposition coordinates are respectively calculated for the projectors 16b to 16e by using the coordinate information and the result of feature point matching, and a pointer image is superimposed on the respective display videos.

### Fourth Embodiment

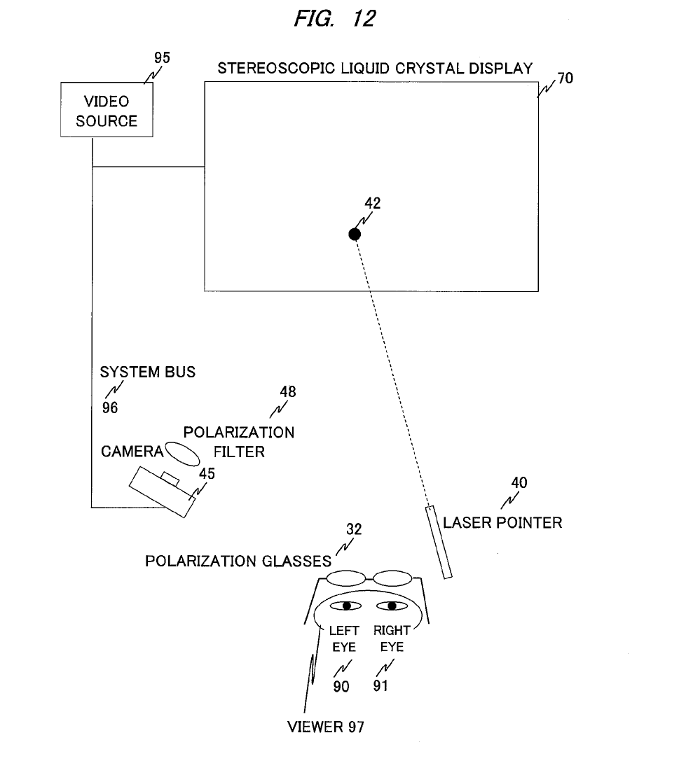

While a projector has been assumed as a display device in the above-described embodiments, the display device according to the present invention is not limited to the projector. In the present embodiment, an example using a liquid crystal display as the display device is illustrated. This will be described based on a system configuration illustrated in FIG. 12.

In FIG. 12, 70 denotes a stereoscopic liquid crystal display. In this case, a liquid crystal display having a polarization filter attached to its front surface is assumed. The polarization filter has a structure in which a polarization direction is alternately changed for each horizontal pixel line position of a liquid crystal panel. More specifically, the polarization direction is alternately switched in such a manner that the polarization is right-hand circular polarization in the first pixel line of the liquid crystal panel, is left-hand circular polarization in the subsequent pixel line, and is right-hand circular polarization in the third pixel line.

Here, when a left-eye video is displayed on odd-numbered lines and a right-eye video is displayed on even-numbered lines of a display video and this is viewed through polarization glasses 32 in which circular polarization filters having different polarization directions are attached for left and right eyes, the left-eye video is presented to the left eye and the right-eye video is presented to the right eye, and are recognized as a 3D image by the brain of a human.

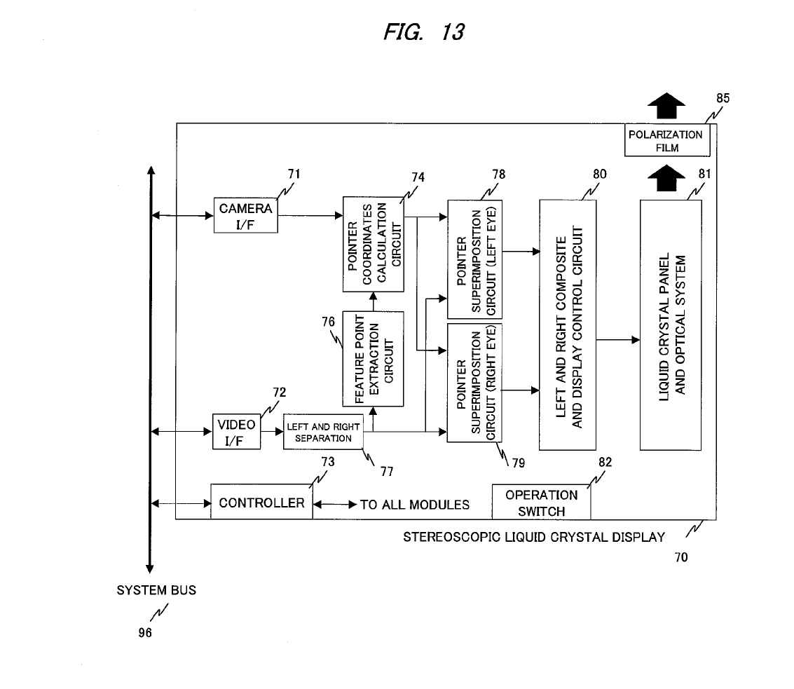

In the present embodiment, infrared light is emitted by a laser pointer 40 to a display surface of the liquid crystal display 70, and a spot of the infrared light that appears on the display surface of the liquid crystal display is captured by the camera 45. Then, the position pointed to by the pointer is calculated from a capturing result and is superimposed on left and right videos. More specifically, a basic idea is close to that in the first embodiment, but the present embodiment and the first embodiment differ in an implementing method. This will be described by using an internal structure of a liquid crystal display illustrated in FIG. 13.

In the present embodiment, the video source 95 exists outside the liquid crystal display 70, but a module for generating a video may be provided inside a housing of the liquid crystal display 70 like a liquid crystal television set having a built-in television tuner.

The video input from the video source 95 is received by a video interface 72. At this point of time, left and right videos remain interleaved for each line as described above. By extracting it by a left and right separation circuit 77 every other line, the left and right videos can be acquired.

Then, for the left and right videos thus acquired, the pointer coordinates are calculated by using a feature point extraction circuit 76 and a pointer coordinate calculation circuit 74 in the same manner as that in the first embodiment, and a pointer image is superimposed respectively on the left and right videos by pointer superimposition circuits 78 and 79. Next, the left and right videos after the superimposition of the pointer image are mixed every other line by a left and right composite and display control circuit 80, thereby generating a composite image of the left and right videos. The left and right composite and display control circuit 80 includes a display timing generating circuit and a gamma adjustment circuit specific to a liquid crystal panel.

The image thus generated is displayed by liquid crystal panel and optical system 81. Since a polarization film 85 described above is attached to a front surface of the liquid crystal panel, the left and right videos are mixed and displayed with their polarization directions changed.

Then, when this is viewed through polarization glasses 32 whose polarization direction has been adjusted so that the left-eye video is viewed by only a left eye and the right-eye video is viewed by only a right eye like in the first embodiment, a three-dimensional video on which the pointer image has been superimposed can be viewed.

What is claimed is:

1. A video display system comprising:
a display device that displays a video, which constitutes a stereoscopic video, on its surface; and
a light beam emitting device capable of pointing to one point with scattering light obtained by projecting a non-visible light beam or a visible light beam onto the surface,
wherein the display device has a camera capable of capturing the scattering light and a superimposition unit that superimposes a pointer image on a display video, and
the superimposition unit superimposes the pointer image on the display video depending on a position of the scattering light captured by the camera.

2. A three-dimensional video pointing device, comprising:
three-dimensional video display means made up of video input means for inputting a first video corresponding to a viewpoint from a left-eye position of a person who views a video and a second video corresponding to a viewpoint from a right-eye position of the person, video processing means for processing each video input from the video input means, and video display means for superimposing each of the videos processed by the video processing means on an overlapping display region, thereby displaying the videos as a third video;
left and right video separation means which is disposed between the display region of the video and the person who views the video, separates the first video and the second video from the third video, and supplies the first video and the second video to the left eye and the right eye of the person, respectively;
pointing means which emits a non-visible light, thereby generating a light illumination region for specifying a first position in the display region;
capturing means for capturing the display region; and
captured video analysis means for analyzing a video captured by the capturing means,
wherein the captured video analysis means acquires a first positon in the display region from the video captured by the capturing means, and calculates first coordinates serving as coordinates in the first video corresponding to the first position in the display region and second coordinates serving as coordinates in the second video corresponding to the first position in the display region based on this,
the video processing means superimposes a pattern indicating a pointed position on the first coordinates in the first video and the second coordinates in the second video, and
the display means displays the video on which the pattern is superimposed by the video processing means, and points to the first position specified by the pointing means onto a three-dimensional video space constructed by the first video and the second video.

3. A three-dimensional video pointing device, comprising:
three-dimensional video display means made up of video input means for inputting a first video corresponding to a viewpoint from a left-eye position of a person who views a video and a second video corresponding to a viewpoint from a right-eye position of the person, video processing means for processing each video input from the video input means, and video display means for superimposing each of the videos processed by the video processing means on an overlapping display region, thereby displaying the videos as a third video;
left and right video separation means which is disposed between the display region of the video and the person who views the video, separates the first video and the second video from the third video, and supplies the first video and the second video to the left eye and the right eye of the person, respectively;
pointing means which emits a visible light, thereby generating a light illumination region for specifying a first position in the display region;
capturing means for capturing the display region; and
captured video analysis means for analyzing a video captured by the capturing means,
wherein the captured video analysis means acquires a first positon in the display region from the video captured by the capturing means, directly uses the first position in the display region as first coordinates serving as coordinates in the first video based on this, and calculates second coordinates serving as coordinates in the second video corresponding to the first position in the display region,
the video processing means superimposes a pattern indicating a pointed position on the first coordinates in the first video and the second coordinates in the second video, and
the display means displays the video on which the pattern is superimposed by the video processing means, and points to the first position specified by the pointing means onto a three-dimensional video space constructed by the first video and the second video.

4. The three-dimensional video pointing device according to claim 3,
wherein the pattern to be superimposed on the second coordinates in the second video is made to have a color and a shape similar to those of a pattern of the light illumination region generated by the pointing means, thereby performing no superimposition of the pattern onto the first video.

5. The three-dimensional video pointing device according to claim 2,
wherein the left and right video separation means is polarization glasses provided with light transmission means having different polarization directions for left and right eyes.

6. The three-dimensional video pointing device according to claim 2,
wherein the left and right video separation means is shutter glasses having a shutter structure which opens and closes at different timings for left and right eyes.

7. The three-dimensional video pointing device according to claim 2,
wherein the video display means is a projector.

8. The three-dimensional video pointing device according to claim 2,
wherein the video display means is a flat panel display.

9. A video display device that displays a video, which constitutes a stereoscopic video, on its surface, comprising:
a camera that captures scattering light emitted from a light beam emitting device, which points to one point by the scattering light obtained by projecting a non-visible light beam or a visible light beam onto the surface; and
a superimposition unit that superimposes a pointer image on a display video,
wherein the superimposition unit superimposes the pointer image on the display video depending on a position of the scattering light captured by the camera.
